(19) United States
(12) Patent Application Publication
(10) Pub. No.: US 2021/0260822 A1
(43) Pub. Date: Aug. 26, 2021

(54) ELECTROSTATIC PARTICLE SPREADER FOR POWDER BED FUSION ADDITIVE MANUFACTURING

(71) Applicant: Lawrence Livermore National Security, LLC, Livermore, CA (US)

(72) Inventor: Eric ELTON, Livermore, CA (US)

(21) Appl. No.: 16/796,461

(22) Filed: Feb. 20, 2020

(51) Int. Cl. B29C 64/205; B33Y 30/00; B05B 5/08

(52) U.S. Cl. CPC B29C 64/205; B05B 5/087; B05B 5/081; B33Y 30/00

(57) ABSTRACT

The present disclosure involves a powder particle deposition system for use with an additive manufacturing system, for moving powder particles without physical contact, to recreate a powder bed. The system uses a powder particle container forming a first electrode. A second electrode is spaced apart from the powder particle container and arranged non-parallel to the powder particle container. A signal source applies an electrical signal across the first and second electrodes to create an electric field between the electrodes which varies in strength, such that the electric field is stronger at one side of the powder particle container. This causes the powder particles to move out from the powder container, toward the second electrode, and then to be repelled by the second electrode and to fall onto the powder bed.

### STATEMENT OF GOVERNMENT RIGHTS

The United States Government has rights in this invention pursuant to Contract No. DE-AC52-07NA27344 between the U.S. Department of Energy and Lawrence Livermore National Security, LLC, for the operation of Lawrence Livermore National Laboratory.

### FIELD

The present disclosure relates to additive manufacturing systems and methods, and more particularly to systems and methods for controllably spreading feedstock (e.g., powder) through the use of electric fields to form a powder bed material layer, which may then be operated on using a powder bed fusion additive manufacturing system and method.

### BACKGROUND

The statements in this section merely provide background information related to the present disclosure and may not constitute prior art.

Powder bed fusion is an additive manufacturing (“AM′) process that joins powder particles using chemical or heat processes to build parts from individual layers of powder. An essential part of the process is the ability to spread a uniform layer of powder each time a new layer is required.

Current AM technologies typically use a hopper for containing the powder particles, and a spreader bar or roller disposed at a specified height above the previously formed material layer of a part, to spread (i.e., push) the powder across the entire powder bed, to form a powder bed of relatively small, uniform thickness. Present day additive manufacturing (“AM”) systems must deal with the challenge of uneven spreading of powders in forming the powder bed. The conventional method of using a spreader bar or roller to push the powder along the powder bed has several downsides. For one, powder particles larger than the gap size being dragged and creating defects in the powder bed. This can create defects such as grooves or troughs in the uppermost surface of the powder bed, which can affect the uniformity of particle dispersion. These defects can affect the quality and/or integrity of the final part. Another drawback is powder bed contamination from the degradation of the spreader bar, and powder contamination from the addition of powder flow aids designed to help powder flow in front of the spreader bar. Powder contamination can likewise negatively affect the quality and/or integrity of the finished part.

Accordingly, there is a need in the art for better control over spreading powder feedstock material to form a highly uniform thickness powder bed, but without the drawbacks associated with conventional spreader bar/roller spreading methods.

### SUMMARY

This section provides a general summary of the disclosure, and is not a comprehensive disclosure of its full scope or all of its features.

In one aspect the present disclosure relates to a powder particle deposition system for use with an additive manufacturing system, for moving powder particles without physical contact to recreate a powder bed. The powder particle deposition system may comprise a powder particle container forming a first electrode, a second electrode spaced apart from the powder particle container and arranged non-parallel to the powder particle, and a signal source. The signal source applies an electrical signal across the first and second electrodes to create an electric field between the first and second electrodes. The electric field varies in strength along the counter electrode such that the electric field is stronger at one side of the powder particle container. This causes the powder particles to move out from the powder container, toward the second electrode, and then to be repelled from the second electrode and to fall onto the powder bed.

In another aspect the present disclosure relates to a powder particle deposition system for use with a powder bed fusion additive manufacturing system, for moving powder particles without physical contact to recreate a powder bed that is acted on by the powder bed fusion additive manufacturing system. The powder particle deposition system may comprise a powder particle container having a bottom wall, and forming a first electrode. A second electrode may be included which is spaced apart from the powder particle container and arranged at an angle of between 5 degree to 70 degrees relative to non-parallel to the powder particle. A conducting mesh may be included which forms a portion of the first electrode, and which extends laterally of the powder particle container and non-parallel to the second electrode. A signal source may be included for applying an electrical signal across the first and second electrodes to create an electric field that extends between the first electrode and the second electrode and the conducting mesh. The electric field varies in strength along the counter electrode such that the electric field is greatest between the second electrode and the conducting mesh. A movement mechanism may be included for moving the powder container and the second electrode over a powder bed. The powder particles are caused by the electric field to move out from the powder container, toward the second electrode, and then to be repelled by the second electrode and to fall toward the conducting mesh, wherein at least a portion of the particle powders falling toward the conducting mesh fall through the conducting mesh onto the powder bed as the movement mechanism is moved over the powder bed.

In still another aspect the present disclosure relates to a powder particle deposition method for use with a powder bed fusion additive manufacturing system, for moving powder particles without physical contact to recreate a powder bed. The powder particle deposition method may comprise using a powder particle container to form a first electrode, and using a second electrode, spaced apart from the powder particle container, which is arranged non-parallel to the powder particle container. A signal source may be used to apply an electrical signal across the first and second electrodes to create an electric field between the first and second electrodes, the electric field varying in strength such that the electric field is stronger at one side of the powder particle container. The electric field may be used to move powder particles out from the powder container, toward the second electrode, wherein the powder particles are then repelled from the second electrode and fall onto the powder bed.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and the drawings are not intended to limit the scope of the present disclosure.

Corresponding reference numerals indicate corresponding parts throughout the several views of the drawings.

FIG. 1 is a system in accordance with one embodiment of the present disclosure in which the system creates and controls an electric field to move electrically conductive powder particles out of a powder container and onto a powder bed, as the powder container and the counter electrode are swept in unison over the powder bed;

FIG. 2 is a high level schematic view of another embodiment of the present disclosure, which is similar to FIG. 1, but which is specifically adapted for using electrically non-conductive powder particles, and where a corona electrode is used as the counter electrode to electrically charge the powder particles, and where an AC signal is used to create an alternating electric field for moving the non-conductive powder particles out from the powder container and onto the powder bed;

FIG. 3 is shows the system of FIG. 2 being used such that the AC signal used to create the alternating electric field between the powder container and the corona electrode causes the powder particles in the powder container to move with a “hopping” motion out of the powder container and onto the powder bed;

FIG. 4 is a schematic view of the system of FIG. 1 being controlled such that the electric field operates to selectively move only smaller sized particles from within the powder container to the powder bed;

FIG. 5 is view of the system of FIG. 4 being used to form two distinct materials layers having differing densities of powder particles, where an initial layer has only smaller powder particles, and an uppermost layer has both smaller and standard sized powder particles;

FIG. 6 is a high level perspective view of another embodiment of an electrode that may be used with the systems of FIGS. 1 and 2, which includes three independent electrode sections, which enable controllably depositing different types of powder particles in different regions of a single powder layer;

FIG. 7 shows the electrode of FIG. 6 in operation being swept over a build plate to controllably deposit different powder particles to form a powder layer having three distinct powder regions;

FIG. 8 shows the plan view of the powder bed better illustrating the three distinct powder particle regions; and

FIG. 9 shows another example of a powder bed formed with distinctly different regions along a full length thereof, but controlling on/off operation of different ones of the counter electrodes of FIG. 6.

### DETAILED DESCRIPTION

Example embodiments will now be described more fully with reference to the accompanying drawings.

This present disclosure relates to systems and methods for spreading small layers of conducting or non-conducting powder feedstock using electric fields for powder bed fusion additive manufacturing processes. Several electrode geometries are disclosed, including planar and corona electrodes, which may be applicable for different types of powder. Several unique applications are also disclosed including deposition of particle beds with graded densities, graded materials, and limited bed size deposition. Importantly, the various embodiments and methods disclosed herein allow for the deposition of powders to form a powder bed without a spreader bar, and therefore without risk of contamination from other materials that may be carried on the spreader bar. In addition, this various embodiments disclosed herein enable a number of features not afforded by current spreading technologies. Such features include the deposition of different particle sizes in different locations of the powder bed, the deposition of different types of powder in different locations of the powder bed, and the deposition of powder in a limited region of the build area resulting in a smaller powder bed. All of the foregoing features may be realized using conducting or non-conducting powders.

General Operation

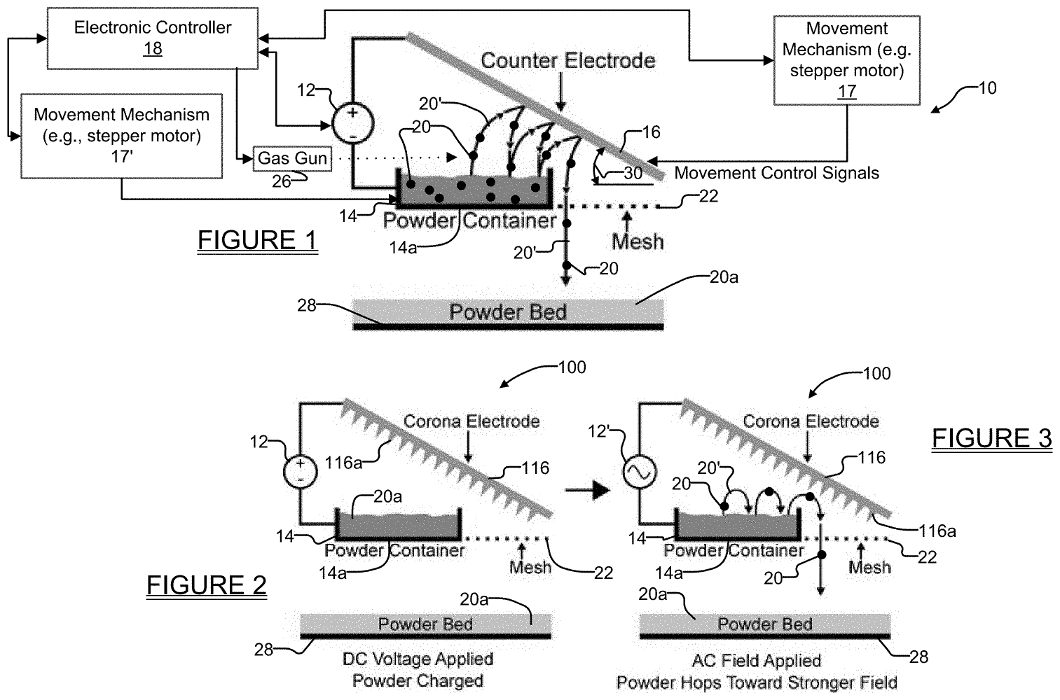

Referring to FIG. 1, one embodiment of a system 10 in accordance with the present disclosure is shown. In the system 10, a DC power source 12 applies a DC signal across a powder particle container 14 (hereinafter simply “powder container” 14) and a counter electrode 16 to form an electric field therebetween. The electric field may be controlled using an electronic controller 18 which controls a function generator or high voltage power supply. The powder container 14 contains a quantity of powder particles 20. An electrically conducting mesh 22 is arranged to extend laterally beyond one side of the powder container 14 and in this example is arranged parallel to a floor 14a of the powder container, and non-parallel to the counter electrode 16. In one embodiment the electrically conducting mesh is electrically connected to the powder container 14, which itself is also made from an electrically conductive material, for example metal. As such, in one example the powder particle container 14 and the conducting mesh 22 are held at the same voltage potential, which in this example is ground potential, but it need not necessarily be ground potential. Although not strictly necessary, the powder bed should be far enough away from the container and mesh that a minimal electric field exists between them, or the powder bed should be at the same potential as the powder container and mesh.

The counter electrode 16 may be formed by an electrically conducting, generally flat material having a thickness which enables it to form a rigid plate. In one embodiment the counter electrode 16 is a metal plate having a thickness of about 0.25 inch (3.175 mm). The counter electrode 16 is supported by suitable structure (not shown) so that, in one embodiment, it may be held stationary, while in other embodiments it may be moved closer to or farther away from the conducting mesh 22, and/or its angle changed, as will be described in greater detail in the following paragraphs.

A principal feature of the system 10 is that the electric field strength is non-uniform between the container 14/mesh 22 and counter electrode 16. This is due to the angled orientation of the counter electrode 16 and the fact that one end thereof extends closer toward the conducting mesh 22. Thus, the electric field between the conducting mesh 22 and the lower rightmost portion of the counter electrode 16 in FIG. 1 is the strongest, and the electric field weakens moving to the left, with the electric field being the weakest between the upper left portion of the counter electrode 16 and the powder container 14.

In this example the conducting mesh and the powder container are held at the same potential.

The conducting mesh 22 in one embodiment forms a screen-like structure made from an electrically conductive material, in one example metal, and has a large plurality of small openings. The openings should be at least slightly larger than the diameter of the powder particles 20. In many AM applications the diameter of the powder particles 20 will be around 20 microns. As such, the size of each opening in the conducting mesh may be at least about 0.5 mm to about 1.0 mm, or possibly even larger.

The strength of the electric field may also be increased through other geometries of the counter electrode 16, or by arrangements of multiple electrodes at different applied voltages. As such, the present disclosure is not limited to only a planar, plate-like counter electrode 16. The example shown in the system 10 is only one specific configuration of the counter electrode 16, but a plurality of different non-planar counter electrode configurations may be suitable for generating the needed electrical field. Movement of the powder container 14 may not be necessary to deposit powder particles in a uniform manner across the entire powder bed, depending on various factors including the size and construction of the counter electrode 16, the dimensions of the conducting mesh 22, and other factors.

Spreading of an Electrically Conductive Powder

The electrically conductive powder particles 20 will rapidly acquire a charge when they contact an electrode, in this case the counter electrode 16 or the powder container 14 (which is acting as an electrode). If the electric field is strong enough, the powder particles 20 will move between electrodes in the electric field (i.e., between the powder container 14 and the counter electrode 16). To use the system 10, the conductive powder particles 20 are first placed in the powder container 14. The powder container 14 in this example forms a grounded conductive container. A voltage difference using the DC signal source 12 is applied between the powder container 14 and the counter electrode 16 such that the powder particles 20 acquire a sufficient charge to move out from the powder container 14 towards the counter electrode 16. Once the powder particles 20 contact the counter electrode 16 they acquire a charge similar to the counter electrode 16, and are then repelled away from the counter electrode. Since the counter electrode 16 is held at an angle non-parallel to the powder container 14, and since the conducting mesh 22 extends laterally of the powder container 14, this extends the electric field laterally of the powder container. The powder particles 20 will move towards the stronger electric field, which is between the conducting mesh 22 and the lower rightmost portion of the counter electrode 16 in FIG. 1. As the powder particles 20 are repelled from the counter electrode 16, they eventually fall through the conducting mesh 22. The lines 20′ indicate the movements of the powder particles 20. After falling through the conducting mesh 22, the powder particles 20 collect on a substrate or build plate 28 to form a powder bed 20a. The angle 30 of the counter electrodel6 relative to the upper surface of the powder particle 20 in the powder container 14 may vary, but is preferably in a range of about 5-70 degrees, and in one specific embodiment within a range of about 20-40 degrees. Changing the angle of the counter electrode 16 will strengthen or weaken the electric field, causing particles to move faster or slower. Such changes may be desired to vary the number of powder particles 20 moving through the conducting mesh 22. Changing the angle will also affect which parts of the powder container 14 the powder particles 20 are removed from, which may lead to depletion of powder particles before the powder bed 20a is fully placed. Optionally, a movement mechanism 17 (e.g., stepper motor operably associated with structure supporting the counter electrode 16) may be used to move the counter electrode 16 closer to or farther from the mesh 22, and/or to even change the angle of the counter electrode 16 relative to the conducting mesh 22 to further modify the electric field. As such, the counter electrode 22 may be movable about two or more orthogonal axes, and these two orthogonal movements may occur while a sweep is taking place. Still further, an optional gas gun 26 may be used to generate a gas flow (e.g., air, argon, etc.) across the powder container 14 toward the counter electrode 16. This gas flow may be used to help move powder particles 20 which are in flight laterally of the powder container 14 toward the highest strength area of the electric field (i.e., over the conducting mesh 22).

Spreading of Electrically Non-Conductive Powder

Non-conductive powder particles do not rapidly exchange charge when they contact an electrode and will not acquire a charge from a planar electrode. Instead, pointed electrodes are required to produce an electrical corona which charges the particles. Such a pointed electrode is shown in FIGS. 2 and 3. FIG. 2 shows a system 100 which is similar to the system 10, and components in common with the system 10 are denoted with the same reference numbers used in FIG. 1. To avoid cluttering the drawing, the electronic controller 18, the movement mechanisms 17 and 17′ are not shown in FIG. 2, although it will be appreciated that these components may be used with the system 100 as well.

The system 100 differs from the system 10 primarily in the use of a corona electrode 116 having a pointed, tooth-like surface 116a. Once charged by the electric field between the powder container 14 and the corona electrode 116, the non-conductive powder particles 20 will remain attracted to the corona electrode 116 for a significantly longer time than conductive powder particles.

During use of the system 100, the non-conductive powder particles 20 are first placed in the conductive powder container 14. The non-conductive powder particles 20 are then charged using the corona electrode 116. After the non-conductive particles 20 have become charged, an oscillating potential is applied between the corona electrode 116 and the powder container 14 using an AC signal source 12′, as indicated in FIG. 3. The AC signal source 12′ may be controlled by the electronic controller 18 as well.

When an AC field is oscillated at an appropriate frequency, the electrically charged powder particles 20 will appear to “hop” off the electrode (i.e., the powder container 14) as they move towards the corona electrode 116, which has the opposite polarity of their charge. As the electrically charged powder particles 20 hop, they move towards the stronger electric field caused by the smaller gap at the end of the corona electrode 116 (indicated by lines 20′ in FIG. 3) and eventually fall through the openings in the conducting mesh 22 onto the powder bed 20a. Optionally, another force, such as a gas flow from gas gun 26, could also be used to further help move “hopping” particles over the conducting mesh 22.

After the powder particles 20 are initially charged, the polarity of the corona electrode 116 and the powder container 14 could be reversed, and the powder particles will move towards the corona electrode 116 where they become electrostatically attracted and attached to the corona electrode. The polarity of the voltage from the signal source 12′ is again switched, and the powder particles 20 will move away from the corona electrode 116. Due to the angle and placement of the corona electrode 116 (which may be similar to, or different from, that of angle 30 discussed in connection with the system 10 of FIG. 1), the powder container 28 and the conducting mesh 22, some powder particles 20 will fall through the openings in the conducting mesh 22 onto the powder bed 20a. The process of alternating the polarity of the signal source 12′ is repeated as necessary to move a sufficient quantity of the powder particles 20 out from the powder container 14 and onto the powder bed 20a. Optionally, separate electrodes could be used to charge the powder particles 20 and move the powder particles away from the powder container 14. The corona electrode 116 could also be moved (i.e., closer to the powder bed 20a or laterally further over the conducting mesh 22, and/or its angle relative to the conducting mesh 22 modified), after the powder particles 20 are attracted to it to allow for even greater powder transfer to the powder bed 20a. The angle of the corona electrode 116 may be operated in the same range as that set forth for the counter electrode 16.

Deposition of Powders of Different Size From Same Powder Container

The electric field necessary to cause a powder particle 20 to move away from the powder container 14 is proportional to the size of the powder particle. Thus, by modulating the applied electric field between the counter electrode 16 (or 116) and the powder container 14, powder particles 20 of different sizes can be removed from a powder container. For example, at low applied fields, only small particles 20b can be removed from the powder container 14, but as the electric field strength is increased, powder particles of larger sizes are also removed from the powder container.

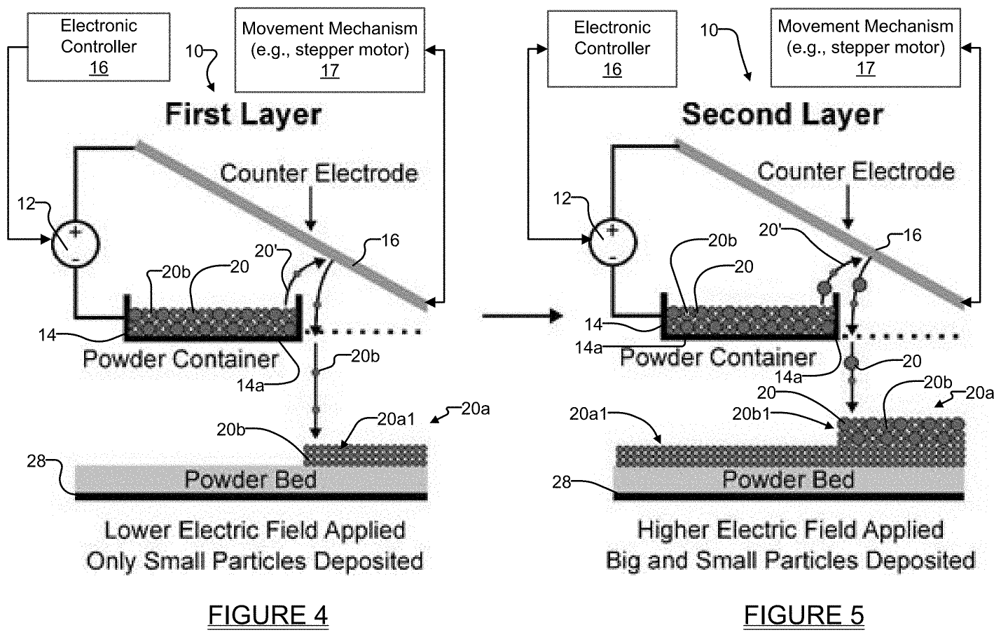

By changing the electric field strength for different powder layers, powder particles 20 of different sizes can be deposited on different layers, leading to a powder bed 20a with layers of varying density. This is illustrated in FIGS. 4 and 5. In FIG. 4 the powder bed 20a is formed with an uppermost layer of only smaller powder particles 20b. But in FIG. 5, the powder bed 20a is formed by two distinct layers 20a1 and 20a2, with the layer 20a1 including only smaller powder particles 20a1, and the layer 20b1 formed on top of the layer 20a1 and including a mixture of the smaller powder particles 20b and the standard sized powder particles 20. Furthermore, the electric field strength may also be changed by controlling the DC signal source 12 as powder particles 20 or 20b are deposited over the length of the powder bed 20a, leading to powder bed density changes (i.e., differing concentrations of smaller and standard sized powder particles) within the same layer. The electric field strength may be adjusted during a given sweep by changing the applied voltage from the signal source 12, and/or by changing the proximity of the counter electrode 16 (or 116) to the powder container 14, and/or by optionally changing the angle 30 (shown in FIG. 1) of the counter electrode 16, or even by moving the counter electrode 16 (or 116) laterally in one lateral direction or back and forth laterally (perpendicular to the axis of movement during a sweep) in an “S” pattern during a sweep. All of these techniques for controlling electric field strength may be used together during an entirety, or even during just portions, of each sweep of the powder bed 20a. It will be appreciated that FIGS. 4 and 5 have omitted the movement mechanisms 17 and 17′ to avoid cluttering the drawing, although these components may still be used during the operations described above for creating layers with differing particle characteristics. Additional details of electric field requirements for moving particle particles may be found in Novick et al., “Minimum dc Electric Field Requirements for Removing Powder Layers From a Conductive Surface”, Journal of Applied Physics 65, 3242 (1989), the entirety of which is hereby incorporated by reference into the present disclosure.

The powder bed density affects the final part, and variable powder density is desirable in some applications. Varying the powder bed 20a density with current technologies is difficult if not impossible since all powder must be spread in the same sweep. The systems 10 and 100 of the present disclosure allow for the powder bed density to be varied in a single “sweep” of the powder spreader over the powder container 14, as well as from layer-to-layer while a 3D part is being formed with a powder bed fusion additive manufacturing system.

Spreading of Segregated Multiple Powders on a Single Layer

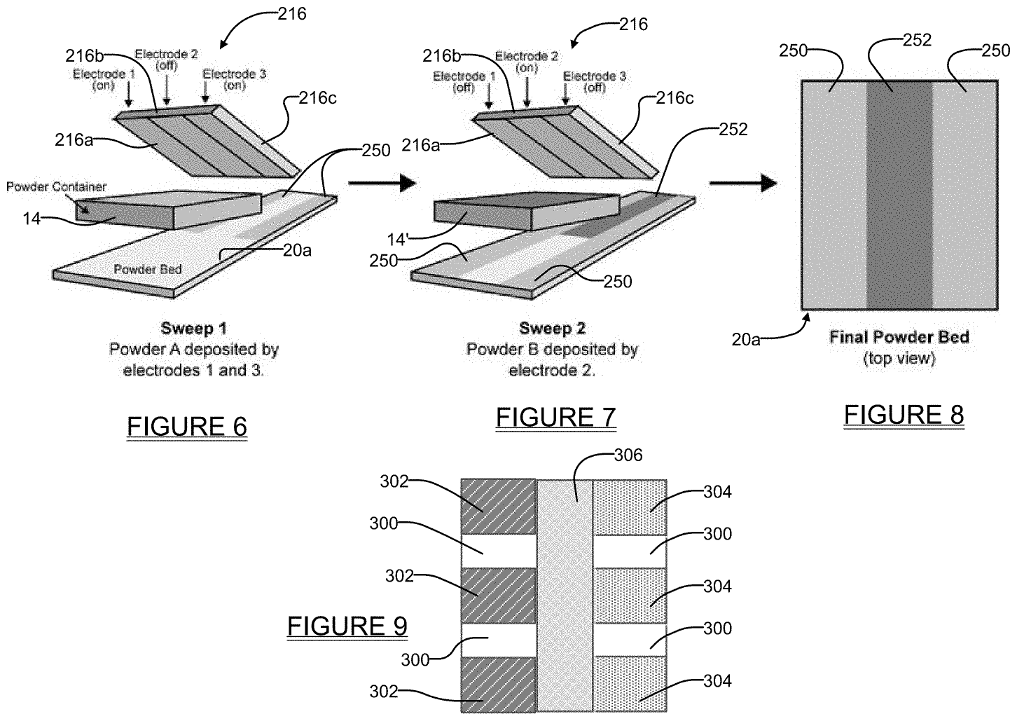

Referring to FIGS. 6-7, the placement of multiple counter electrodes across the full width of the powder container 14 can be used to facilitate the deposition of different powders on the same layer. For example, FIGS. 6 and 7 show a counter electrode subsystem 216 constructed of three independent counter electrodes 216a, 216b and 216c. The three counter electrodes 216a, 216b and 216c are dimensioned in this example with a width sufficient to each cover one-third the width of the powder bed 20a. In one operation sequence, the two outer counter electrodes 216a and 216c are kept at the same voltage, using the signal source 12, as the powder container 14 for the first pass over the powder bed 20a, while no signal is applied to the center counter electrode 216b. This results in two separate stripes 250 of the first powder particles 20 being deposited on the powder bed 20a. A second powder container 14′ (FIG. 7) is then placed beneath the counter electrode subsystem 216, and a voltage from the signal source 12 is only applied to the middle counter electrode 216b while both the powder container 14′ and the counter electrode subsystem 216 are moved (i.e., swept) across the powder bed 20a. This causes the powder particles 20 from the second powder container 14′ to be deposited only in the middle of the previously deposited stripes of the first powder, while no powder particles are moved by the outermost counter electrodes 216a and 216c. This causes a distinct powder stripe 252 to be formed using only the center counter electrode 216b. The result is a powder bed with two different materials placed on the same layer, in two successive deposition operations, as shown in FIG. 8.

Alternatively, the counter electrodes 216a-216c could be selectively switched on and off at different locations as the powder container 14 and the counter electrode subsystem 216 moves, leading to a powder bed with a controlled, spatial pattern perpendicular to the direction of motion of the powder spreader. An example of a complete powder layer formed with distinct types or concentrations of powder regions is shown in FIG. 9. Regions 300 and 302 may be formed along one linear stripe by controllably switching on (forming regions 302) and off (regions 300) counter electrode 216a. Regions 300 are devoid of powder particles 20 while regions 302 have a first density or type of powder particles 20. Similarly, regions 300 and 304 may be formed by controllably switching on and off the counter electrode 216c. In this example regions 304 have a different density or type of powder particle from the regions 302 (i.e., a different type of powder particle in regions 304 would necessitate using a powder container loaded with the different powder particles). The central region 306 may be formed by maintaining the center counter electrode 216b turned on continuously for a full sweep, and creating a density or region of powder particles which differs from regions 302 and 304 (i.e., a different type of powder particle deposition in region 306 would necessitate using a container loaded with that type of powder particle). Accordingly, regions 300, 302, 304 and 306 each may represent a subregion of the powder bed having either no powder particles, or different types and/or densities of powder particles. The power to one or more of the counter electrodes 216a-216c may also be varied linearly or non-linearly during a full sweep, to create still further variations in construction of the powder bed. Still further, the powder container 14 and the counter electrode subsystem 216 could be moved in a non-linear path to further vary the shapes of various subregions of powder particles and/or densities created. Still further, the angle of the counter electrode 16, and/or the corona electrode 116, and/or the electrode subsystem 216, relative to the powder container 14, could be changed in real time during an electric field sweep to further controllably alter how powder particles are deposited on the powder bed 20a. Thus, a combination of these techniques can be used to create complex patterns and/or densities of powder particle deposition. The width and number of counter electrodes in the counter electrode subsystem 216 could therefore be selected to optimize deposition patterns, as well as possibly controlled to simultaneously deposit powder particles 20 in an on/off manner only during select portions of a sweep.

Still further, the various embodiments of the system 10, the counter electrode 16 and the corona electrode 116, could be modified to incorporate two or more counter electrodes that surround the powder container 14 (i.e., extend laterally of the powder container) to enable deposition of powder particles 20 laterally of two sides, three sides, or all four sides, of the powder container. This may be accomplished by including a plurality of pairs of counter electrode 16 and conducting mesh 22, with each pair arranged circumferentially around the powder container 14, to extend laterally from all four sides of the powder container. Such a configuration would effectively form a counter electrode “tent” over and under the powder container 14, with the counter electrode of each pair being above and extending laterally beyond one side of the powder container, and the conducting mesh 22 of each pair extending out laterally from an associated side of the powder container.

It will also be appreciated that the counter electrode 16 (and/or corona electrode 116 and/or counter electrode subsystem 216) could form photoelectrodes that only become conductive when light is shined on them. In this configuration, a light projector may be used to controllably illuminate the counter electrode 16, the corona electrode 116 or the counter electrode subsystem 216. This control technique could be used to make the counter electrode 16 or the corona electrode 116 conductive at select times as a sweep is taking place. It may also be used to make one or more portions (or all) of the counter electrode subsystem 216 conductive at select times during a sweep.

The systems and methods of the present disclosure overcome the challenges of forming a powder bed without a conventional spreader structure. The systems and methods remove any risk of contamination to the particle bed by a physical spreader component which is being moved in contact with the upper surface of the powder bed, as well as irregularities in the surface caused by “pushing” movement of particles which are non-uniform to the majority of powder particles forming the powder bed. The systems and methods of the present disclosure further open up a number of new control methodologies for tailoring the powder bed with differing powder particle densities over its full area, and/or with different types of particles, which would not be possible with a conventional powder spreader element.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A powder particle deposition system for use with an additive manufacturing system, for moving powder particles without physical contact to recreate a powder bed, the powder particle deposition system comprising:
a powder particle container forming a first electrode;
a second electrode spaced apart from the powder particle container and arranged non-parallel to the powder particle; and
a signal source for applying an electrical signal across the first and second electrodes to create an electric field between the first and second electrodes, the electric field varying in strength along the counter electrode such that the electric field is stronger at one side of the powder particle container, causing the powder particles to move out from the powder container toward the second electrode, and then to be repelled from the second electrode and to fall onto the powder bed.

2. The system of claim 1, further comprising a movement mechanism for moving the powder container and the second electrode over a powder bed.

3. The system of claim 1, wherein the first electrode is formed by the powder container and an electrically conductive mesh supported above the powder bed and laterally of the powder particle container, the electrically conductive mesh helping to form a portion of the electric field that extends laterally beyond the powder particle container.

4. The system of claim 1, wherein:
the second electrode comprises a counter electrode; and
the powder particles comprise electrically conductive powder particles.

5. The system of claim 4, wherein the signal source comprises a DC signal source for applying a DC signal to the counter electrode.

6. The system of claim 1, wherein:
the second electrode comprises a corona electrode having a plurality of teeth; and
the powder particles comprise non-conductive powder particles.

7. The system of claim 6, wherein the signal source comprises an AC signal source for applying an AC signal between the powder container and the corona electrode.

8. The system of claim 1, wherein the second electrode is disposed at an angle of between 5 degrees to 70 degrees relative to the powder particle container.

9. The system of claim 3, wherein the conducting mesh is held at a ground potential.

10. The system of claim 1, further comprising a movement mechanism for moving the counter electrode relative to the powder particle container.

11. The system of claim 1, further comprising a movement mechanism for moving the counter electrode relative to the powder particle container.

12. The system of claim 1, wherein the second electrode comprises a plurality of independent electrode elements that are controlled independently of one another.

13. A powder particle deposition system for use with a powder bed fusion additive manufacturing system, for moving powder particles without physical contact to recreate a powder bed that is acted on by the powder bed fusion additive manufacturing system, the powder particle deposition system comprising:
a powder particle container having a bottom wall, and forming a first electrode;
a second electrode spaced apart from the powder particle container and arranged at an angle of between 5 degree to 70 degrees relative to non-parallel to the powder particle;
a conducting mesh, which forms a portion of the first electrode, and which extends laterally of the powder particle container and non-parallel to the second electrode;
a signal source for applying an electrical signal across the first and second electrodes to create an electric field that extends between the first electrode and both of the second electrode and the conducting mesh, the electric field varying in strength along the counter electrode such that the electric field is greatest between the second electrode and the conducting mesh; and
a movement mechanism for moving the powder container and the second electrode over a powder bed, the powder particles being caused by the electric field to move out from the powder container, toward the second electrode, and then to be repelled from the second electrode and to fall toward the conducting mesh, wherein at least a portion of the particle powders falling toward the conducting mesh fall through the conducting mesh onto the powder bed as the movement mechanism is moved over the powder bed.

14. The system of claim 13, wherein the second electrode is supported at an angle of 5 degrees to 70 degrees relative to a bottom wall of the powder particle container.

15. The system of claim 13, wherein the conducting mesh is supported parallel to a bottom wall of the powder particle container.

16. The system of claim 13, wherein:
the signal source comprises a DC signal source; and
the second electrode comprises a counter electrode which receives a DC signal from the DC signal source.

17. The system of claim 13, wherein:
the signal source comprises an AC signal source; and
the second electrode comprises a corona electrode which receives an AC signal from the AC signal source.

18. The system of claim 13, wherein the second electrode comprises an electrode assembly including a plurality of adjacently disposed, independently energizable electrodes.

19. The system of claim 13, further comprising a movement mechanism for moving the second electrode while the second electrode and the powder container are being swept over a powder bed.

20. A powder particle deposition method for use with a powder bed fusion additive manufacturing system, for moving powder particles without physical contact to recreate a powder bed, the powder particle deposition method comprising:
using a powder particle container to form a first electrode;
placing a second electrode spaced apart from the powder particle container and arranged non-parallel to the powder particle;
using a signal source to apply an electrical signal across the first and second electrodes to create an electric field between the first and second electrodes, the electric field varying in strength such that the electric field is stronger at one side of the powder particle container; and
using the electric field to move powder particles out from the powder container, toward the second electrode, wherein the powder particles are then repelled from the second electrode and fall onto the powder bed.

21. The method of claim 20, further comprising:
using a conducting mesh arranged non-parallel to the second electrode to extend the electric field out laterally from the powder particle container, wherein the electric field has a maximum strength between the second electrode and the conducting mesh; and
using the conducting mesh to draw powder particles from the second electrode onto the powder bed.
